(19) United States
(12) Patent Application Publication
(10) Pub. No.: US 2023/0017335 A1
(43) Pub. Date: Jan. 19, 2023

(54) SYSTEMS AND METHODS FOR CANONICAL CONSTRUCTION OF QUANTUM ORACLES

(71) Applicant: JPMORGAN CHASE BANK, N.A., New York, NY (US)

(72) Inventors: Constantin GONCIULEA, Upper Arlington, OH (US); Austin GILLIAM, Columbus, OH (US); Marco PISTOIA, Amawalk, NY (US)

(21) Appl. No.: 17/662,296

(22) Filed: May 6, 2022

Related U.S. Application Data
(60) Provisional application No. 63/185,227, filed on May 6, 2021.

(51) Int. Cl. G06N 10/80; G06N 10/20

(52) U.S. Cl. CPC G06N 10/80; G06N 10/20

(57) ABSTRACT

A method for solving a problem using a quantum oracle may include a classical computer program: selecting an implementation for a problem from one or more different implementations in a dictionary of implementations; preparing the implementation using bounds on a quantum circuit to solve the problem and encoding input data for the problem into a quantum state; selecting an oracle to monitor and measure the quantum state based on the implementation, wherein the oracle identifies a pattern of interest in the quantum state; transpiling the prepared implementation and the oracle into a set of machine-readable instructions; sending the set of machine-readable instructions to a quantum computer, wherein the quantum computer executes the set of machine-readable instructions and returns an array of results, the array of results representing measurements of the quantum state using the oracle; and analyzing the array of results and outputting the analysis.

### RELATED APPLICATIONS

This application claims priority to, and the benefit of, U.S. Provisional Patent Application Ser. No. 63/185,227 filed May 6, 2021, the disclosure of which is hereby incorporated, by reference, in its entirety.

### BACKGROUND OF THE INVENTION

### 1. Field of the Invention

Embodiments are generally directed to systems and methods for canonical construction of quantum oracles.

### 2. Description of the Related Art

Selecting a set of basis states is a common task in quantum computing in order to increase and/or evaluate the probabilities of a set of basis states. This is similar to designing “where” clauses in classical database queries. A common automation approach uses oracles with classical evaluation of all the states at circuit design time. This is inefficient because the number of basis states scales exponentially with the number of qubits (i.e., 2ⁿ for n qubits), so parsing through even a subset of these classically quickly becomes inefficient.

### SUMMARY OF THE INVENTION

Systems and methods for canonical construction of quantum oracles are disclosed. In one embodiment, a method for solving a problem using a quantum oracle may include a classical computer program: (1) selecting an implementation for a problem from one or more different implementations in a dictionary of implementations; (2) preparing the implementation using bounds on a quantum circuit to solve the problem and encoding input data for the problem into a quantum state; (3) selecting an oracle to monitor and measure the quantum state based on the implementation, wherein the oracle identifies a pattern of interest in the quantum state; (4) transpiling the prepared implementation and the oracle into a set of machine-readable instructions; (5) sending the set of machine-readable instructions to a quantum computer, wherein the quantum computer executes the set of machine-readable instructions and returns an array of results, the array of results representing measurements of the quantum state using the oracle; and (6) analyzing the array of results and outputting the analysis.

In one embodiment, the method may also include receiving, by the classical computer program, an input that describes the problem and bounds on the quantum circuit to solve the problem.

In one embodiment, the method may also include generating, by the classical computer program, an oracle quantum circuit for the oracle.

In one embodiment, the method may also include compiling, by the classical computer program, the prepared implementation and oracle quantum circuit according to a quantum algorithm, wherein the classical computer program transpiles the prepared implementation and the oracle quantum circuit into the set of machine-readable instructions.

In one embodiment, the problem may include an integer problem, a partition problem, a polynomial problem, a quantum problem, a Quadratic unconstrained binary optimization (QUBO) problem, or a sum problem.

In one embodiment, the quantum circuit may include a number of key bits, a number of value bits, and a number of result bits.

In one embodiment, the key bits may include a binary representation of a key, and the value bits may include binary representations of values.

In one embodiment, the key bits may include an index of a value, and the value bits may include the value in binary.

In one embodiment, the key bits may correspond to a presence or absence of a binary variable, and the value bits may correspond to an associated coefficient in binary.

In one embodiment, the classical computer program may also receive a number of iterations for the quantum computer.

In one embodiment, the oracle may amplify the identified quantum state.

In one embodiment, the step of transpiling, by the classical computer program, the compiled prepared implementation and oracle quantum circuit into a set of machine-readable instructions may include: transpiling, by the classical computer program, the prepared implementation into a first set of machine-readable instructions; and transpiling, by the classical computer program, the oracle quantum circuit into a second set of machine-readable instructions; wherein the set of machine-readable instructions may include the first set of machine-readable instructions and the set of machine-readable instructions.

According to another embodiment, a system may include a classical computer comprising a classical computer processor; and a memory storing a classical computer program that cause the classical computer program to receive an input that describes a problem and bounds on a quantum circuit to solve the problem; select an implementation for the problem from one or more different implementations in a dictionary of implementations; prepare the implementation using the bounds on the quantum circuit and encoding input data for the problem into a quantum state; select an oracle to monitor and measure the quantum state based on the implementation, wherein the oracle identifies a pattern of interest in the quantum state, generate an oracle quantum circuit for the oracle, compile the prepared implementation and oracle quantum circuit for according to a quantum algorithm; transpile the compiled prepared implementation and oracle quantum circuit into a set of machine-readable instructions; and send the set of machine-readable instructions to a quantum computer; and a quantum computer that receives the set of machine-readable instructions, executes the set of machine-readable instructions, and outputs an array of results, the array of results representing measurements of the quantum state using the oracle; wherein the classical computer program analyzes the array of results and outputs the analysis.

In one embodiment, the problem may include an integer problem, a partition problem, a polynomial problem, a quantum problem, a Quadratic unconstrained binary optimization (QUBO) problem, or a sum problem.

In one embodiment, the bounds on the quantum circuit may include a number of key bits, a number of value bits, and a number of result bits.

In one embodiment, the key bits may include a binary representation of a key, and the value bits may include binary representations of values, or the key bits may include an index of a value, and the value bits may include the value in binary, or the key bits may correspond to a presence or absence of a binary variable, and the value bits may correspond to an associated coefficient in binary.

In one embodiment, the classical computer program may also receive a number of iterations for the quantum computer.

In one embodiment, the oracle may amplify the identified quantum state.

In one embodiment, the classical computer may transpile the compiled prepared implementation and oracle quantum circuit into a set of machine-readable instructions by transpiling the prepared implementation into a first set of machine-readable instructions and transpiling the oracle quantum circuit into a second set of machine-readable instructions, wherein the set of machine-readable instructions may include the first set of machine-readable instructions and the set of machine-readable instructions.

According to another embodiment, a non-transitory computer readable storage medium, including instructions stored thereon, which when read and executed by one or more computer processors the one or more computer processors to perform steps comprising: receiving an input that describes a problem and bounds on a quantum circuit to solve the problem; selecting an implementation for the problem from one or more different implementations in a dictionary of implementations; preparing the implementation using the bounds on the quantum circuit and encoding input data for the problem into a quantum state; selecting an oracle to monitor and measure the quantum state based on the implementation, wherein the oracle identifies a pattern of interest in the quantum state; generating an oracle quantum circuit for the oracle; compiling the prepared implementation and oracle quantum circuit for according to a quantum algorithm; transpiling the compiled prepared implementation and oracle quantum circuit into a set of machine-readable instructions; sending the set of machine-readable instructions to a quantum computer, wherein the quantum computer executes the set of machine-readable instructions and returns an array of results, the array of results representing measurements of the quantum state using the oracle; and analyzing the array of results and outputting the analysis.

In one embodiment, the problem may include an integer problem, a partition problem, a polynomial problem, a quantum problem, a Quadratic unconstrained binary optimization (QUBO) problem, or a sum problem.

In one embodiment, the bounds on the quantum circuit may include a number of key bits, a number of value bits, and a number of result bits, wherein the key bits may include a binary representation of a key, and the value bits may include binary representations of values, or the key bits may include an index of a value, and the value bits may include the value in binary, or the key bits may correspond to a presence or absence of a binary variable, and the value bits may correspond to an associated coefficient in binary.

In one embodiment, the instructions further cause the classical computer program to transpile the compiled prepared implementation and oracle quantum circuit into a set of machine-readable instructions by transpiling the prepared implementation into a first set of machine-readable instructions and transpiling the oracle quantum circuit into a second set of machine-readable instructions, wherein the set of machine-readable instructions may include the first set of machine-readable instructions and the set of machine-readable instructions.

According to another embodiment, a method for solving a problem using a quantum oracle may include: (1) receiving, by a classical computer program executed by an electronic device, an input that describes a problem and bounds on a quantum circuit to solve the problem; (2) selecting, by the classical computer program, an implementation for the problem from one or more different implementations in a dictionary of implementations; (3) preparing, by the classical computer program, the implementation using the bounds on the quantum circuit and encoding input data for the problem into a quantum state; (4) selecting, by the classical computer program, an oracle to monitor and measure the quantum state based on the implementation, wherein the oracle identifies a pattern of interest in the quantum state; (5) generating, by the classical computer program, an oracle quantum circuit for the oracle; (6) compiling, by the classical computer program, the prepared implementation and oracle quantum circuit for according to a quantum algorithm; (7) transpiling, by the classical computer program, the compiled prepared implementation and oracle quantum circuit into a set of machine-readable instructions; (8) sending, by the classical computer, the set of machine-readable instructions to a quantum computer, wherein the quantum computer executes the set of machine-readable instructions and returns an array of results, the array of results representing measurements of the quantum state using the oracle; and (9) analyzing, by the classical computer program, the array of results and outputting the analysis.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for canonical construction of quantum oracles according to one embodiment; and

FIG. 2 depicts a method for canonical construction of quantum oracles according to one embodiment.

### DETAILED DESCRIPTION OF PREFERRED EMBODIMENTS

Embodiments are directed to systems and methods for canonical construction of quantum oracles.

The disclosures Gilliam et al. “Canonical Construction of Quantum Oracles” (2020) available at arxiv.org/abs/2006.10656, and Gilliam et al. “Foundational Patterns for Efficient Quantum Computing” (2019) available at arxiv.org/abs/1907.11513 are hereby incorporated, by reference, their entireties. In addition, the disclosures of U.S. Provisional Patent Application Ser. No. 62/978,252 filed Feb. 18, 2020, and U.S. patent application Ser. No. 17/178,058 filed Feb. 17, 2021, are hereby incorporated, by reference, in their entireties.

Embodiments are directed to a canonical way to produce a quantum oracle from an algebraic expression (in particular, an Ising model), that maps a set of selected states to the same value, coupled with a simple oracle that matches that particular value.

Unlike naive oracle encoding, which is generally inefficient due to the need to check the predicate on all basis states, canonical oracle encoding allows for efficient encoding of properties that can be expressed algebraically as polynomials of binary variables. In particular, quadratic Hamiltonians, such as Ising models, lend themselves to this approach. Embodiments rely on values being associated with all outcomes in such a way that those outcomes satisfy a given property mapped to the same value. This technique may be subsequently used in algorithms such as Amplitude Amplification, Amplitude Estimation, and Quantum Counting.

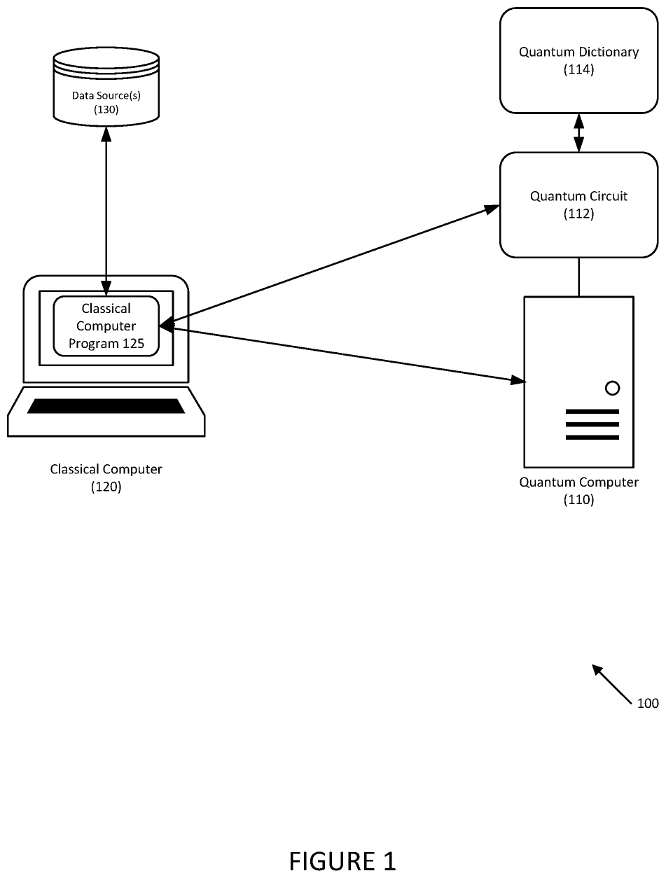

Referring to FIG. 1, a system for canonical construction of quantum oracles is disclosed according to an embodiment. System 100 may include quantum computer 110 that may execute quantum circuit 112. Quantum computer 110 may be device that perform quantum computations, such as those based on the collective properties of quantum states including superposition, interference, and entanglement. Quantum dictionary 114 may include a plurality of quantum computing patterns. Examples of quantum dictionaries are provided in U.S. Provisional Patent Application Ser. No. 63/055,688 filed Jul. 23, 2020, and in Gilliam, et al., “Foundational patterns for efficient quantum computing” (2019), available at arXiv:1907.11513, the disclosures of which are hereby incorporated by reference in their entireties.

Quantum dictionary 114 may replace the manual creation of the quantum state with an automated process, and creates a quantum data structure that is capable of representing multiple problem sets. By standardizing the encoding manner, the oracle may also be standardized, making it more efficient.

Classical computer 120 may be any suitable general purpose computing device, including servers, workstations, desktop, notebook, laptop, or tablet computers, etc. Classical computer 120 may interface with quantum computer program 114 using classical computer program 125, which may provide input to, and receive output from, quantum computer 110. In one embodiment, classical computer program 125 may generate one or more quantum circuits 112, may transpile the quantum circuit(s) 112 to machine-readable instructions, and may then send the transpiled circuit(s) 112 to quantum computer 110 for execution. Classical computer program 125 may also select one or more quantum dictionary patterns from quantum dictionary 114 and may provide the quantum dictionary pattern(s) to quantum computer 110.

Classical computer program 125 may also receive the results of the execution of the one or more quantum circuits 112.

Data source(s) 130 may include one or more sources of data. For example, data source(s) 130 may provide input data, such as the problem to be solved, an identification of the desired quantum computer 110 to execute quantum circuit 112, information on quantum computer 110 (e.g., the number of qubits, fidelity, etc.).

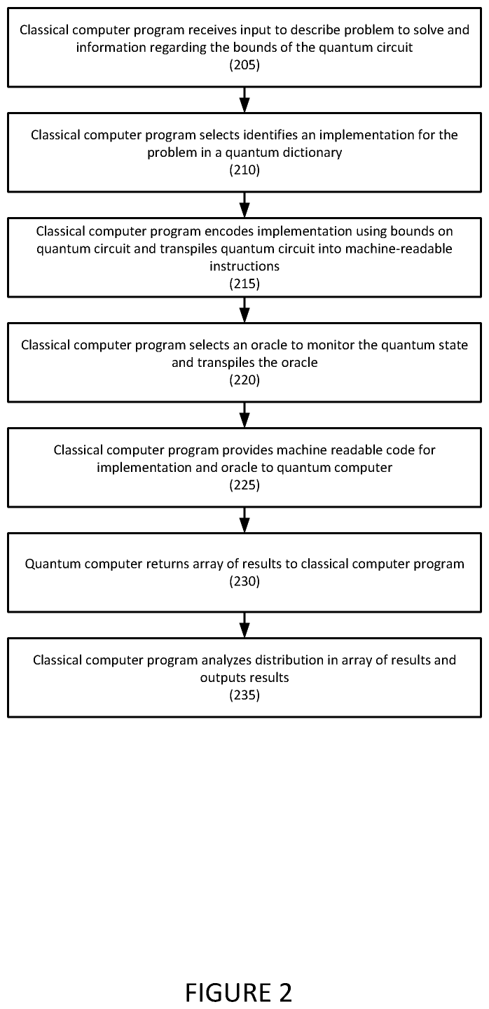

Referring to FIG. 2, a method for quantum computing-assisted asset portfolio selection is disclosed according to an embodiment.

In step 205, a classical computer program may receive input to describe problem to solve and information regarding the bounds of the quantum circuit to solve the problem. In one embodiment, the classical computer program may receive a data structure having a form and content that correspond to the problem to be solved. For example, the problem may be an integer problem, a partition problem, a polynomial problem, a quantum problem, a Quadratic unconstrained binary optimization (QUBO) problem, a sum problem, etc. In one embodiment, the computer program may provide, for example, a drop-down box for receiving the problem.

The classical computer program may receive, for the bounds on the quantum circuit, a number of key bits, a number of value bits, and a number of result bits. In one embodiment, the representation of the key bits and the value bits may be problem dependent. For example, if a map of key-value pairs is to be encoded, the key bits may be the binary representation of the key, and similar for the values. If an array is being encoded (e.g., [0, 1, 2, 3]), then the key bits may be the index of the value, and the value bits may be the value itself (in binary). In a QUBO problem, the key bits may correspond to the presence (or lack thereof) of a binary variable, and the value bits may correspond to the associated coefficient in binary.

The number of result bits may be an estimate provided by the user. The number required is also problem-dependent, and in certain cases may not be necessary. The number may be refined based on the results as is necessary and/or desired.

In embodiments, the user may also identify the number of times that the quantum circuit is to be run and measured.

In one embodiment, the user may identify the type of quantum computer to execute the quantum circuit.

In step 210, the classical computer program may select an implementation for the problem from one or more different implementations in the quantum dictionary. Each implementation in the quantum dictionary may be specific to a specific problem (e.g., integer problem, partition problem, polynomial problem, quantum, QUBO problem, sum problem, etc. Examples of quantum dictionaries are provided in U.S. Provisional Patent Application Ser. No. 63/055,688 filed Jul. 23, 2020, and in Gilliam, et al., “Foundational patterns for efficient quantum computing” (2019), available at arXiv:1907.11513, the disclosures of which are hereby incorporated by reference in their entireties. The classical computer program may select the implementation that matches the problem received from the user.

In step 215, the classical computer program may prepare the implementation using the bounds on the quantum circuit that specify how many registers are needed, how many qubits are in each register, and then what quantum gates/operations are applied to each qubit in a specific sequence. It may also encode input data, such as one or more array, and may put the input data into the quantum state by putting them in a state of superposition and then entangling them. Using, for example, an algorithm library and any circuit-specific properties (e.g., number of key bits, value bits, etc.), the result is a full quantum circuit that is designed to solve the problem.

The classical computer program then transpiles the quantum circuit into machine-readable instructions.

In step 220, based on the implementation, the classical computer program may select an oracle to monitor and measure the quantum state. In one embodiment, the implementation in the quantum dictionary may identify one or more quantum states to measure. The oracle may identify a pattern of interest in the quantum state. Examples of patterns of interest may include the probability of a single state, the probability of a set of states satisfying a property, the number of states that satisfy a certain property, the number of states with a non-zero amplitude, the number of states with a value (e.g., 0 or another value) in a register, combinations of any of the foregoing, etc. These patterns of interest are illustrative only, and it should be recognized that other patterns of interest may be used as is necessary and/or desired.

The oracle is used to amply the identified quantum state(s) using, for example, Grover's Algorithm. A description of Grover's Algorithm may be found, for example, in L. K. Grover, “A fast quantum mechanical algorithm for database search,” Proceedings 28th Annual Symposium on the Theory of Computing (STOC) 1996, pp. 212-219, the disclosure of which is hereby incorporated, by reference, in its entirety.

The classical computer program may then generate a quantum circuit for the oracle, and may transpile the oracle into a set of machine-readable instructions.

In one embodiment, the quantum circuit for the problem and the quantum circuit that represents the oracle may be complied together according to a quantum algorithm (e.g., Grover's Algorithm) to create a full quantum circuit. The full quantum circuit may then be transpiled.

In step 225, the classical computer program may provide the quantum circuits to the quantum computer, which may then execute the quantum circuits for the specified number of iterations.

In step 230, the quantum computer may return an array of results to the classical computer program, and in step 235, the classical computer program may analyze the distribution of the array of results and may output the results. The result data may be the number of times measured for each outcome. For example, for two qubits and 1024 iterations, the results may be in a form such as {‘00’: 251, ‘01’: 213, ‘10’: 260, ‘11’: 300}, where the key (e.g. ‘00’) is the outcome measured, and the value (e.g. 251) is how many times that outcome was measured.

In step 235, the classical computer program may analyze the distribution in an array of results and may output a result. The result may be the most frequently measured value, the distribution of measured values, etc.

In one embodiment, the results may be output in any suitable manner. For example, the results may be output graphically using, for example, pixel graphs.

Although several embodiments have been disclosed, it should be recognized that these embodiments are not exclusive to each other, and certain elements or features from one embodiment may be used with another.

All documents cited in this application have been incorporated, by reference, in its entirety.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer, etc. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for solving a problem using a quantum oracle, comprising:
selecting, by a classical computer program executed by a classical computer, an implementation for a problem from one or more different implementations in a dictionary of implementations;
preparing, by the classical computer program, the implementation using bounds on a quantum circuit to solve the problem and encoding input data for the problem into a quantum state;
selecting, by the classical computer program, an oracle to monitor and measure the quantum state based on the implementation, wherein the oracle identifies a pattern of interest in the quantum state;
transpiling, by the classical computer program, the prepared implementation and the oracle into a set of machine-readable instructions;
sending, by the classical computer, the set of machine-readable instructions to a quantum computer, wherein the quantum computer executes the set of machine-readable instructions and returns an array of results, the array of results representing measurements of the quantum state using the oracle; and
analyzing, by the classical computer program, the array of results and outputting the analysis.

2. The method of claim 1, further comprising:
receiving, by the classical computer program, an input that describes the problem and bounds on the quantum circuit to solve the problem.

3. The method of claim 1, further comprising:
generating, by the classical computer program, an oracle quantum circuit for the oracle.

4. The method of claim 3, further comprising:
compiling, by the classical computer program, the prepared implementation and oracle quantum circuit according to a quantum algorithm, wherein the classical computer program transpiles the prepared implementation and the oracle quantum circuit into the set of machine-readable instructions.

5. The method of claim 1, wherein the problem may include an integer problem, a partition problem, a polynomial problem, a quantum problem, a Quadratic unconstrained binary optimization (QUBO) problem, or a sum problem.

6. The method of claim 1, wherein the bounds on the quantum circuit comprise a number of key bits, a number of value bits, and a number of result bits.

7. The method of claim 6, wherein the key bits comprise a binary representation of a key, and the value bits comprise binary representations of values.

8. The method of claim 6, wherein the key bits comprise an index of a value, and the value bits comprise the value in binary.

9. The method of claim 6, wherein the key bits correspond to a presence or absence of a binary variable, and the value bits correspond to an associated coefficient in binary.

10. The method of claim 1, wherein the classical computer program further receives a number of iterations for the quantum computer.

11. The method of claim 1, wherein the oracle amplifies the identified quantum state.

12. The method of claim 4, wherein the step of transpiling, by the classical computer program, the compiled prepared implementation and oracle quantum circuit into a set of machine-readable instructions may include:
transpiling, by the classical computer program, the prepared implementation into a first set of machine-readable instructions; and
transpiling, by the classical computer program, the oracle quantum circuit into a second set of machine-readable instructions;
wherein the set of machine-readable instructions may include the first set of machine-readable instructions and the set of machine-readable instructions.

13. A system, comprising:
a classical computer comprising:
a classical computer processor;
a memory storing a classical computer program that cause the classical computer program to receive an input that describes a problem and bounds on a quantum circuit to solve the problem; select an implementation for the problem from one or more different implementations in a dictionary of implementations; prepare the implementation using the bounds on the quantum circuit and encoding input data for the problem into a quantum state; select an oracle to monitor and measure the quantum state based on the implementation, wherein the oracle identifies a pattern of interest in the quantum state, generate an oracle quantum circuit for the oracle, compile the prepared implementation and oracle quantum circuit according to a quantum algorithm; transpile the compiled prepared implementation and oracle quantum circuit into a set of machine-readable instructions; and send the set of machine-readable instructions to a quantum computer; and
a quantum computer that receives the set of machine-readable instructions, executes the set of machine-readable instructions, and outputs an array of results, the array of results representing measurements of the quantum state using the oracle;
wherein the classical computer program analyzes the array of results and outputs the analysis.

14. The system of claim 13, wherein the problem may include an integer problem, a partition problem, a polynomial problem, a quantum problem, a Quadratic unconstrained binary optimization (QUBO) problem, or a sum problem.

15. The system of claim 13, wherein the bounds on the quantum circuit comprise a number of key bits, a number of value bits, and a number of result bits.

16. The system of claim 15, wherein the key bits comprise a binary representation of a key, and the value bits comprise binary representations of values, or the key bits comprise an index of a value, and the value bits comprise the value in binary, or the key bits correspond to a presence or absence of a binary variable, and the value bits correspond to an associated coefficient in binary.

17. The system of claim 13, wherein the classical computer program further receives a number of iterations for the quantum computer.

18. The system of claim 13, wherein the oracle amplifies the identified quantum state.

19. The system of claim 13, wherein the classical computer transpiles the compiled prepared implementation and oracle quantum circuit into a set of machine-readable instructions by transpiling the prepared implementation into a first set of machine-readable instructions and transpiling the oracle quantum circuit into a second set of machine-readable instructions, wherein the set of machine-readable instructions may include the first set of machine-readable instructions and the set of machine-readable instructions.

20. A non-transitory computer readable storage medium, including instructions stored thereon, which when read and executed by one or more computer processors the one or more computer processors to perform steps comprising:
receiving an input that describes a problem and bounds on a quantum circuit to solve the problem;
selecting an implementation for the problem from one or more different implementations in a dictionary of implementations;
preparing the implementation using the bounds on the quantum circuit and encoding input data for the problem into a quantum state;
selecting an oracle to monitor and measure the quantum state based on the implementation, wherein the oracle identifies a pattern of interest in the quantum state;
generating an oracle quantum circuit for the oracle;
compiling the prepared implementation and oracle quantum circuit according to a quantum algorithm;
transpiling the compiled prepared implementation and oracle quantum circuit into a set of machine-readable instructions;
sending the set of machine-readable instructions to a quantum computer, wherein the quantum computer executes the set of machine-readable instructions and returns an array of results, the array of results representing measurements of the quantum state using the oracle; and
analyzing the array of results and outputting the analysis.

21. The non-transitory computer readable storage medium of claim 20, wherein the problem may include an integer problem, a partition problem, a polynomial problem, a quantum problem, a Quadratic unconstrained binary optimization (QUBO) problem, or a sum problem.

22. The non-transitory computer readable storage medium of claim 20, wherein the bounds on the quantum circuit comprise a number of key bits, a number of value bits, and a number of result bits, wherein the key bits comprise a binary representation of a key, and the value bits comprise binary representations of values, or the key bits comprise an index of a value, and the value bits comprise the value in binary, or the key bits correspond to a presence or absence of a binary variable, and the value bits correspond to an associated coefficient in binary.

23. The non-transitory computer readable storage medium of claim 20, wherein the instructions further cause the classical computer program to transpile the compiled prepared implementation and oracle quantum circuit into a set of machine-readable instructions by transpiling the prepared implementation into a first set of machine-readable instructions and transpiling the oracle quantum circuit into a second set of machine-readable instructions, wherein the set of machine-readable instructions may include the first set of machine-readable instructions and the set of machine-readable instructions.
